(19) United States
(12) Patent Application Publication
(10) Pub. No.: US 2018/0071621 A1
(43) Pub. Date: Mar. 15, 2018

(54) Gaming System, Kit, and Method for Enabling Interactive Play

(71) Applicants: Tao Xu, Westmont, IL (US); Ying Li, Shenzen (CN); Xiaojun Zhang, Shenzen (CN); Linzhi Fang, Huizou (CN)

(72) Inventors: Tao Xu, Westmont, IL (US); Ying Li, Shenzen (CN); Xiaojun Zhang, Shenzen (CN); Linzhi Fang, Huizou (CN)

(21) Appl. No.: 15/265,642

(22) Filed: Sep. 14, 2016

(51) Int. Cl. A63F 13/24; A63F 13/235; A63F 13/92; A63F 13/52

(52) U.S. Cl. CPC A63F 13/24; A63F 13/52; A63F 13/92; A63F 13/235

(57) ABSTRACT

A gaming system, kit and attendant methodology provide users with overlapping real-virtual world interactive play. The gaming kit outfits and enables a user's smart phone or tablet type computer to enable virtual gaming upon the visual display thereof. A user-operable control device separate from the computer includes circuitry housing and signal-transmitting circuitry housed within the circuitry housing. The user-operable control device generates and transmits virtual object control signals enabled via the signal-transmitting circuitry. A signal-communicating mechanism receives virtual object control signals from the control device and communicates the virtual object control signals to the user's computer. A computer-implementable gaming application is deployable via the computer for providing a controllable and visually displayed virtual object upon the electronic visual display. The virtual object is virtually controllable in a gaming environment by way of the control signals sent from the user-operable control device and communicated to the computer via the signal-communicating mechanism.

### BACKGROUND OF THE INVENTION

### Field of the Invention

The present invention generally relates to a gaming system for enabling gamers to simultaneously and interactively play with both a physical world control object (or control device) and a virtual world controllable object within a virtual gaming environment. More particularly, the present invention relates to the provision of a system of components and software application implementable by a user's computer for enabling a controllable gaming experience by a hand-held control object reflective of the virtual object within the gaming environment.

### Brief Description of the Prior Art

U.S. Patent Application Publication No. 2004/0080494, authored by Fahlman, discloses a Force-Sensing Mouse Pointing Device for Computer Input. The '494 Publication describes a mouse device having a set of force sensors that measure vertical force with respect to the surface on which the mouse moves and pass information to the computer system in question. The mouse output can be used for: 1) downward force; 2) tilt in several directions; and 3) rotation. To sense tilt variations, the mouse device may preferably comprise three or four feet having an independent vertical force sensor on each of the feet.

U.S. Patent Application Publication No. 2010/0331087 ('087 Publication), authored by Argenter, discloses a Control Apparatus for Use with a Computer of Video Game System. The '087 Publication describes a device for controlling a display of a computer system for use with a video game. The device includes a coordinate control unit for providing information related to a vertical and horizontal tilt of the control device, a mouse control unit for inputting conventional mouse input information, a game control unit for inputting game control information and a controller for processing the information provided by the coordinate control unit, mouse control unit and game control unit. The vertical and horizontal point of view of the user in the video game and/or the vertical and horizontal position of a cursor on the display is determined based on the information related to the vertical and horizontal tilt of the control device. The control device is preferably shaped like a firearm to enhance the realism of the video game, but may also be shaped like a conventional game pad.

U.S. Patent Application Publication No. 2011/0221674 ('674 Publication), authored by Jenssen, discloses a Hand Held Control Device with Dual Mode Joystick for Pointing and Scrolling. The '674 Publication describes a mouse device for moving a visual pointer on a display for computer equipment. The control device is designed to be used hand held free of support from any surface, as the movement of the pointer in two dimensions takes place by means of a guide device or joystick. The guide pin preferably has a double function so that it may also be used for scrolling the display. The control device may include an attachment for the user's hand or wrist, and may be integrated with a telephone receiver or with a remote control for a television set or the like.

U.S. Patent Application Publication No. 2015/0199026 ('026 Publication), authored by Cook et al., discloses certain processes for Viewing Images with Tilt Control on a Hand-Held Device. The '026 Publication describes a user interface suitable for use in cellular phones and personal digital assistants (PDAs), PC Tablets, as well as laptops, PCs, office equipment, medical equipment, or any other hand-held electronic device, that allows control of the image on the device display by tilting the device to either change the view in perspective, change the magnification, or both, concurrently, by moving or tilting the device. Thus, the tilt of the device controls the angle of view of the image, and moving the device perpendicular to the screen controls the magnification. It will thus be understood that the Cook et al. publication teaches certain means for controlling visual information displayed upon a device by movement of the device itself as primarily determined via the use of an accelerometer internal to the device.

U.S. Patent Application Publication No. 2015/0346781 ('781 Publication), authored by Tokutake, discloses an Apparatus and Method for Controlling a Display based on a Manner of Holding the Apparatus. The '781 Publication describes a device having a display panel configured to display one or more interfaces and one or more motion sensors. The device includes circuitry configured to determine, based on an input from the one or more motion sensors, a tilt angle of the device. The circuitry is configured to select, based on the determined tilt angle, an interface, of the one or more interfaces, and to control the display panel to display the selected interface. As with the Cook et al. publication, the Tokutake publication also It will teaches certain means for controlling visual information displayed upon a device by movement of the device itself as primarily determined via the use of a motion sensor internal to the device.

As may be understood from a consideration of the foregoing, the prior art has shown a number of means for controlling activity via the manipulation and/or orientation of a hand-held, user-operable control device. It will be further understood, however, from a review of the foregoing, and the field of hand-held control devices and the like that the prior art perceives a need for a low cost gaming kit whereby a user may be provided with a real world hand-held toy outfitted with simple, low cost electronics for controlling virtual characters within a virtual gaming environment upon a user's communications device or computer via simple real world play with the hand-held toy substantially as summarized hereinafter.

### SUMMARY OF THE INVENTION

The present invention basically provides a gaming system, kit and method for enabling users thereof to experience overlapping real world and virtual world interactive game play upon a user's communications device or computer. Viewed systemically, the gaming invention may be said to preferably comprise or include a computer, a toy type user-operable control device separate from the computer, means for communicating the control device and the computer, and a gaming application or set of gaming software instructions implementable via the computer. The basic idea is to provide a low cost gaming experience to user's having access to a computer and who have an interest in toys of various types.

The gaming system, kit and method thus center on the user-operable control device or toy-type launcher. In this regard, the gaming kit includes an external fanciful or amusing user-operable control device or launcher, as may be variously exemplified by cartoon characters, figurines, or dolls; toy vehicles such as toy motorbikes, cars, trucks, or airplanes; sports equipment such as toy bats, balls, or guns; and certain wearable products such as eyewear. The user-operable control device(s) or launcher(s) can then be manipulated via the user in some manner to control corresponding movements of virtual characters within a gaming environment as displayed upon an electronic visual display of the computer.

Signals generated from within the user-operable control device(s) are transmitted from the user-operable control device(s) and communicated to the user's communications device or computer. While any number of control signals are contemplated, the preferred essential practice of the invention contemplates at least four primary directional signals enabled via the signal-transmitting circuitry of the user-operable control device(s). These four primary directional movement signals may preferably include forward, rearward, leftward and rightward directional signals. The directional movement signals, for example, may then be processed for controlling directional movements of the virtual object as displayed upon the electronic visual display of the user's computer. A preferred optional action button may also be incorporated for enabling the user to selectively input non-directional gaming input signals.

A signal-receiving and signal-relaying mechanism as preferably exemplified by a signal-receiving dongle may also be included within the kit and outfitted upon the user's communications device or computer. The signal-receiving mechanism receives incoming wireless signal(s) and transform these wireless signals into electrical signals. A computer-implementable mobile gaming application separately installed on the user's communications device or computer reads the incoming signals and implements instructions for governing movements or actions of virtual objects or characters within a gaming environment upon the electronic visual display with corresponding movements or actions employed by the user or directed into the user-operable control device.

The user may thus enjoy a gaming experience upon his or her communications device or computer, which gaming experience follows actions implemented by a separate toy or figurine that doubles as a gaming control device. The gaming experience within the virtual gaming environment thus follows the action of the hand-held toy or figurine. Signal-transmitting circuitry of a user-operable control device or launcher matches a specified signal-receiving dongle or mechanism, and the user can direct a virtual character or toy to follow or mimic the real world launcher toy's actions.

The wireless communications enabled via the signal-communicating dongle can be connected with at least four toys at the same time for group play. Noting that Bluetooth connections only allow a single toy to be connected for play, Bluetooth communications are thereby limit gaming scenarios to single player applications. The present application, by contrast enables group play. Further, the circuit design according to the present invention assigns every individual toy its own identification. Thus, no two toys will be treated as the same, even though many different individual toys will have the same or similar appearance (and treated as the same toy in the retail sense). This feature allows the gaming application server to store game play results and achievement levels for each individual toy on a cloud-based server, which can be retrieved when each respective toy is in play the next time or for online interactive gaming.

### BRIEF DESCRIPTIONS OF THE DRAWINGS

Other features of the invention will become more evident from a consideration of the following brief descriptions of the illustrations submitted in support of the subject invention:

FIG. 1 is a depiction of a smart phone-dongle assembly and a tablet type computer-dongle assembly situated in side-by-side relation to another with a signal-communicating mechanism-dongle therebetween.

FIG. 2 is a representation of a series of exemplary user-operable control devices or launchers according to the present invention, including from left to right, a cartoon character figurine-type user-operable control device, a toy motorbike type user-operable control device, a doll figurine type user-operable control device, a toy airplane type user-operable control device, a toy car type user-operable control device, eyewear type user-operable control device, and a ball type user-operable control device.

FIG. 3A is a top plan view of a signal-transmitting launcher mechanism according to the present invention showing the exterior housing of a tilt ball switch assembly operable as part of the signal-transmitting launcher mechanism.

FIG. 3B is a lateral edge view of the signal-transmitting launcher mechanism according to the present invention showing the exterior housing of a tilt ball switch assembly operable as part of the signal-transmitting launcher mechanism.

FIG. 4 is an enlarged depiction of a signal-communicating dongle usable in combination with the present invention.

FIG. 5A is an enlarged depiction of a smart phone apparatus with parts broken away to show an internal processor component.

FIG. 5B is a bottom edge view of the smart phone apparatus otherwise depicted in FIG. 5A to highlight the earphone jack or interface of the smart phone apparatus.

FIG. 6 is an enlarged top perspective view of a toy car type user-operable control device according to the present invention with parts broken away to show an otherwise hidden signal-transmitting launcher mechanism housed within a housing of the toy car type user-operable control device.

FIG. 7 is an enlarged top plan view of a toy car type user-operable control device according to the present invention with parts broken away to show an otherwise hidden signal-transmitting launcher mechanism housed within a housing of the toy car type user-operable control device.

FIG. 8 is an enlarged lateral elevational view of a toy car type user-operable control device according to the present invention with parts broken away to show an otherwise hidden signal-transmitting launcher mechanism housed within a housing of the toy car type user-operable control device.

FIG. 9 is an enlarged lateral view of a toy car type user-operable control device according to the present invention tilted downwardly in a forward direction and with parts broken away to show an otherwise hidden signal-transmitting launcher mechanism housed within a housing of the toy car type user-operable control device.

FIG. 10 is an enlarged lateral view of a toy car type user-operable control device according to the present invention tilted downwardly in a rearward direction and with parts broken away to show an otherwise hidden signal-transmitting launcher mechanism housed within a housing of the toy car type user-operable control device.

FIG. 11 is an enlarged rear end view of a toy car type user-operable control device according to the present invention with parts broken away to show an otherwise hidden signal-transmitting launcher mechanism housed within a housing of the toy car type user-operable control device.

FIG. 12 is an enlarged rear end view of a toy car type user-operable control device according to the present invention tilted downwardly in a leftward direction and with parts broken away to show an otherwise hidden signal-transmitting launcher mechanism housed within a housing of the toy car type user-operable control device.

FIG. 13 is an enlarged rear end view of a toy car type user-operable control device according to the present invention tilted downwardly in a rightward direction and with parts broken away to show an otherwise hidden signal-transmitting launcher mechanism housed within a housing of the toy car type user-operable control device.

FIG. 14 is an enlarged depiction of a smart phone apparatus with a virtual gaming scenario depicted upon the visual display screen of the smart phone apparatus, the virtual gaming scenario including a car type virtual object controllable within a virtual gaming environment of the virtual gaming scenario via the toy car type user-operable control device according to the present invention.

FIG. 15 is an enlarged depiction of a smart phone apparatus with an enlarged vector cross depicted upon the visual display screen of the smart phone apparatus, the vector cross being demonstrative of directional cues for controlling the virtual object within the virtual gaming scenario according to the present invention.

FIG. 16 is a top perspective view of an exemplary current-conductive enclosure of a tilt switch assembly according to the present invention.

FIG. 17 is a top perspective view of an exemplary current-conductive enclosure of a tilt switch assembly according to the present invention.

FIG. 18 is a vertically transverse cross-sectional view of an exemplary current-conductive enclosure of a tilt switch assembly according to the present invention showing an internal spherical body in a central equilibrium position.

FIG. 19 is a vertically transverse cross-sectional view of an exemplary current-conductive enclosure of a tilt switch assembly according to the present invention showing an internal spherical body in a current conductive tilted position.

FIG. 20 is an exploded top perspective view of a first exemplary current-conductive enclosure of a tilt switch assembly according to the present invention showing from top to bottom a ball-corralling shroud, a spherical body, a printed circuit board element, and a non-conductive insert element.

FIG. 21 is an exploded top perspective view of a second exemplary current-conductive enclosure of a tilt switch assembly according to the present invention showing from top to bottom a ball-corralling shroud, a spherical body, a printed circuit board element, and a non-conductive insert element.

FIG. 22 is a horizontally transverse cross-sectional view of a first ball-corralling shroud of a current-conductive enclosure according to the present invention showing a first exemplary set of orientation stopper formations.

FIG. 23 is a horizontally transverse cross-sectional view of a second ball-corralling shroud of a current-conductive enclosure according to the present invention showing a second exemplary set of orientation stopper formations.

FIG. 24 is a plan view of a first printed circuit board of a current-conductive enclosure according to the present invention showing a first exemplary set of radially extending finger portions.

FIG. 25 is a plan view of a second printed circuit board of a current-conductive enclosure according to the present invention showing a second exemplary set of radially extending finger portions.

FIG. 26 is a horizontally transverse cross-sectional view of a first ball-corralling shroud of a current-conductive enclosure according to the present invention showing a spherical body received in a first orientation stopper formation.

FIG. 26A is an enlarged, fragmentary sectional view as sectioned from FIG. 26 to show in greater detail the spherical body received in the first orientation stopper formation.

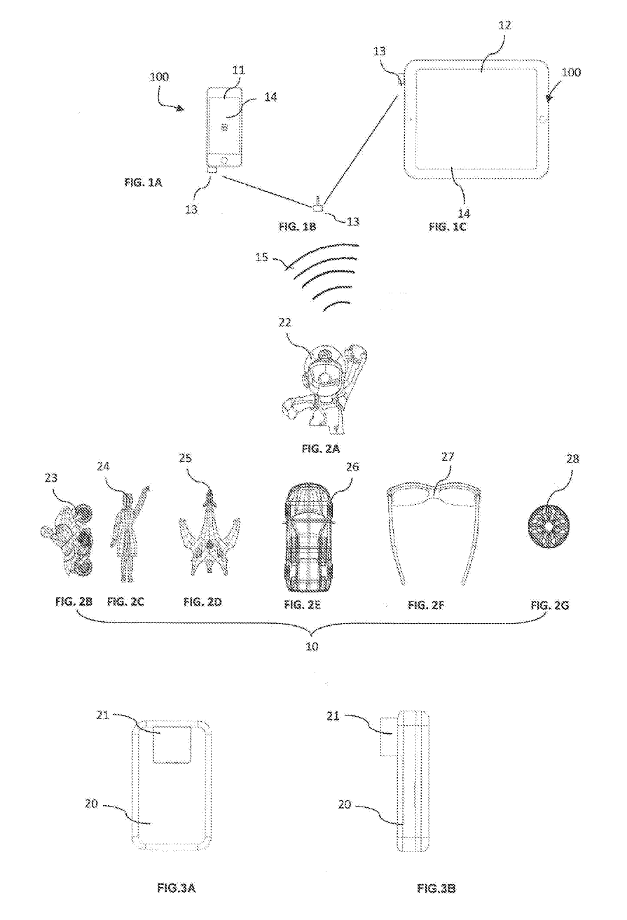

### DETAILED DESCRIPTION OF THE PREFERRED EMBODIMENTS

Referring now to the drawings with more specificity, the present invention preferably provides a gaming system, kit and method for enabling users thereof to experience overlapping real world and virtual world interactive game play upon a user's communications device or computer 100 as exemplified by a smart phone as at 11 or tablet type apparatus as at 12. The gaming system according to the present invention is operable via computer-implementation and thus some basic software-processing means are believed essential to the practice of the present invention. Viewed systemically, the gaming invention may thus be said to preferably comprise or include a computer 100, a user-operable control device separate from the computer 100, means for communicating the control device with the computer 100, and a gaming application or set of software instructions implementable via the computer 100.

Central to the practice of the present gaming invention is the user-operable control device or launcher as variously exemplified or embodied and generically referenced at 10. In this regard, the present invention provides the user with a user-operable control device or launcher 10, as may be variously exemplified by a cartoon character figurine 22, a toy motorbike 23, a doll figurine 24, a toy airplane 25, a toy car 26, certain wearable products such as eyewear 27, a ball 28, etc. The user-operable control device(s) or launcher(s) 10 can then be manipulated via the user in some manner to control corresponding movements of virtual characters within a gaming environment as displayed upon an electronic visual display 14 of the computer 100.

Signals generated from within the user-operable control device(s) 10 are transmitted from the user-operable control device(s) 10 and communicated to the user's communications device or computer 100 exemplified by a smart phone as at 11 or tablet type apparatus as at 12. While any number of virtual object control signals are contemplated, the preferred essential practice of the invention contemplates at least four primary directional signals enabled via the signal-transmitting circuitry of the user-operable control device(s) 10. These four primary directional movement signals may preferably include an anterior or forward directional signal as at 101; a posterior or rearward directional signal as at 102; a left lateral directional signal as at 103; and a right lateral directional signal as at 104.

The directional movement signals, for example, may then be processed for controlling directional movements of a virtual object as displayed upon the electronic visual display 14 of the computer 100. The anterior or forward directional signal 101 may prompt a forward directional movement as at 111; the posterior or rearward directional signal 102 may prompt a rearward directional movement as at 112; the left lateral directional signal 03 may prompt a left lateral directional movement as at 113; and the right lateral directional signal 104 may prompt a right lateral directional movement as at 114.

More particularly, the user may thus play with a hand-operable toy or wearable article to effect some real world action and the signal-transmitting circuitry within the hand-operable toy or wearable article will detect or sense these actions through certain device-orientation sensing means within or made cooperable with the toy (e.g. a gyroscope or ball bearing type switch, sound, light, magnet, temperature, touch, mechanical etc.,) and the signal-transmitting circuitry and sensing means may preferably transform these signals into 2.4G wireless signals as at 15 for further transmission to the user's communication device or computer 100 for controlling virtual game play upon the electronic visual display 14.

A signal-receiving mechanism as exemplified by a signal-receiving dongle 13 is preferably outfitted upon the user's communications device or computer 100. The signal-receiving dongle 13 may be plugged into a signal-receiving interface of the smartphone 11 or tablet 12 as exemplified by an USB input or earphone jack 19. The signal-receiving mechanism or dongle 13 will receive incoming wireless signal(s) and transform these wireless signals into electrical signals. A computer-implementable (mobile) gaming application as generically depicted by APP icon 18 may be separately installed on the user's communications device or computer 100 for reading the incoming signals and implementing instructions for governing movements or actions of virtual objects or characters within a gaming environment upon the electronic visual display 14 with corresponding movements or actions employed by the user or directed into the user-operable control device(s) 10.

The user may thus enjoy a gaming experience upon his or her communications device or computer 100, which gaming experience follows actions implemented by a separate hand-operable toy or figurine or wearable article that doubles as a gaming control device. The gaming experience within the virtual gaming environment thus follows the action of the hand-operable toy or figurine or wearable article. Signal-transmitting circuitry of the toy-type, user-operable control device or launcher 10 communicates with a specified signal-receiving dongle 13 and the user can direct a virtual character to follow the launcher toy's actions.

The signal-transmitting launcher device 10 can be associated with any number of toys, such as a toy car as at 26, a toy airplane as at 25, a toy gun (not specifically illustrated), a doll or similar other fanciful figurine as at character 22 or doll 24, or a ball as at 28. The signal-transmitting circuitry is preferably hidden within a circuitry housing provided by the user-operable control device 10 and communicates with the user's communications device or computer 100 via the signal-receiving mechanism or dongle 13 to effect game play via the gaming application separately installed on the user's communications device or computer 100.

Referencing FIGS. 3A and 3B, the reader will there comparatively consider a signal-transmitting launcher mechanism 20, which signal-transmitting launcher mechanism 20 is preferably incorporated into a user-operable control device 10 exemplified by any number of toys or figurines and which signal-transmitting launcher mechanism 20 may preferably comprise an inexpensive, tilt ball switch assembly as at 21 for generating signals 101, 102, 103, and 104. The signal-transmitting circuity or launcher mechanism 20 necessarily further preferably comprises a signal transmitter as at generic box 30 and a power source or battery as at generic box 31 all in communication with one another via Printed Circuit Board or PCB, examples of which are generally depicted and referenced at element 32.

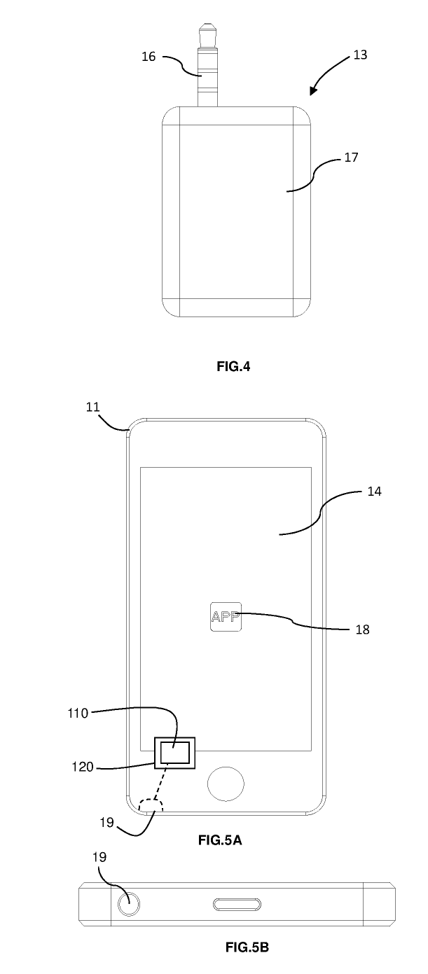

Referencing FIG. 4, the reader will there consider an anterior view of a preferred signal-receiver mechanism or dongle 13 according to the present invention. The signal-receiving mechanism or dongle 13 preferably comprises a 3.5 mm pin plug as at 16 and a signal processing system or signal receiver module as at 17, inclusive of a power system. The signal-receiving mechanism or dongle 13 preferably connects or interfaces with a smartphone 11 or tablet 12 by way of the 3.5 mm pin plug 16, and the signal processing system 17 receives incoming wireless signals 15, transforms or converts the incoming wireless signals 15 into electric signals and outputs those electrical signals to the smartphone 11, tablet 12, television box (not specifically illustrated) all as generally embraced by computer 100. FIG. 5B depicts a bottom edge view of a smartphone 11 with 3.5 mm pin plug 16 insertable into an earphone jack 19 outfitted upon the user's communications device or computer 100.

FIG. 4A generally depicts the anterior face of a typical smartphone 11 usable in combination with or as part of the present invention. When the user downloads and installs a gaming (mobile) application or set of software instructions for governing game play according to the present invention, an application icon as at APP 18 is preferably displayed upon the electronic visual display 14. Once the gaming application is installed upon the user's communications device or computer 100, the specified application may be launched by clicking on the APP icon 18. The gaming application, via the computer 100, establishes communications with the signal-receiving mechanism and the signal-transmitting circuity housed within or otherwise made cooperable with the user-operable control device(s) 10.

When the gaming application is initiated, the electronic visual display 14 displays at least one virtual object as at 33 within a virtual gaming environment according to various specified games. An example of such a gaming environment is basically depicted in FIG. 15. In this case, referencing FIG. 15, the reader will consider virtual object 33. Virtual object 33 is preferably reflective of a real world, user-operable control device 10 exemplified by a toy car 26. The virtual object 33 depicted in FIG. 15 thus resembles a car that corresponds to the toy car 26 type user-operable control device 10. In this case, the gaming environment, also displayed upon the electronic visual display 14, resembles a virtual roadway 35 with a left lane 36 and a right lane 37 with a virtual roadside 38 also depicted with grass 39 and shrubbery 40.

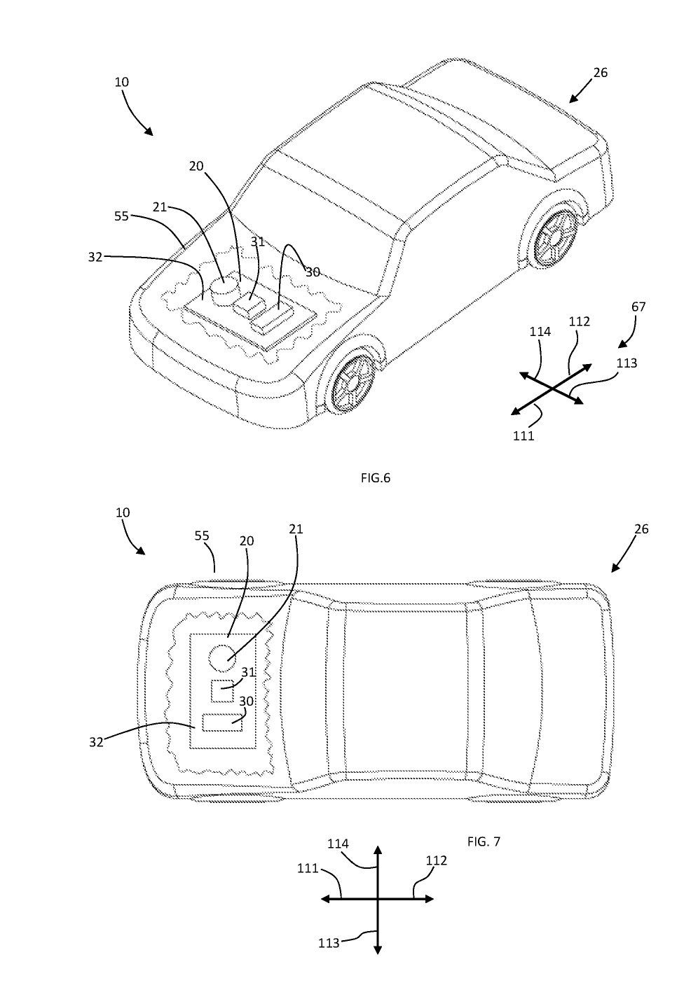

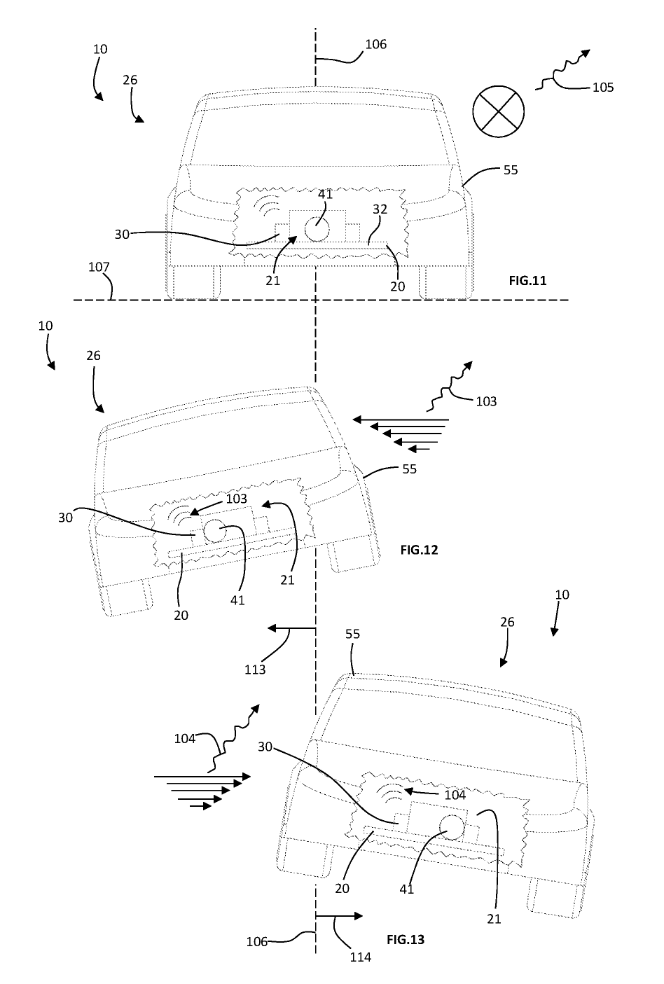

Comparatively referencing FIGS. 6-13, the reader will there consider toy car 26 type user-operable control device 10. Each of the figures is presented with parts broken away to show otherwise the hidden internal signal-transmitting circuitry or launch mechanism 20 outfitted with a tilt ball switch assembly 21. Equilibrium positions are depicted for the toy car 26 type user-operable control device 10 in FIGS. 6, 7, 8, and 11. A forward tilt position is generally depicted in FIG. 9; a rearward tilt position is generally depicted in FIG. 10; a leftward tilt position is generally depicted in FIG. 12; and a rightward tilt position is generally depicted in FIG. 13.

When in the equilibrium position, the user-operable control device 10 will either cease signal transmission or send a signal to cease movement. In the preferred embodiment, the equilibrium position may prompt a movement stop signal as at 105 to the signal-receiving mechanism or dongle 13. When the user-operable control device 10 is manually oriented into a forward tilt positon from equilibrium as generally depicted in FIG. 9, the tilt ball switch assembly 21 closes thereby initiating an anterior or forward directional signal 101 for prompting a forward directional movement as at 111. In this case scenario, the virtual object 33 would correspondingly move with a forward directional movement 111 upon the electronic visual display 14.

Similarly, when the user-operable control device 10 is manually oriented into rearward, leftward, and rightward tilt positons from the equilibrium position as generally and respectively depicted in FIGS. 10, 12, and 13, the tilt ball switch assembly 21 closes, and the user thereby initiates rearward, leftward, and/or rightward directional signals 102, 103, and/or 104 via the user-operable control device 10 for prompting rearward, leftward, and/or rightward directional movements as at 112, 113, and/or 114 respectively. In this case scenario, the virtual object 33 correspondingly moves with a rearward, leftward, or rightward directional movements 112, 113, and/or 114 upon the electronic visual display 14.

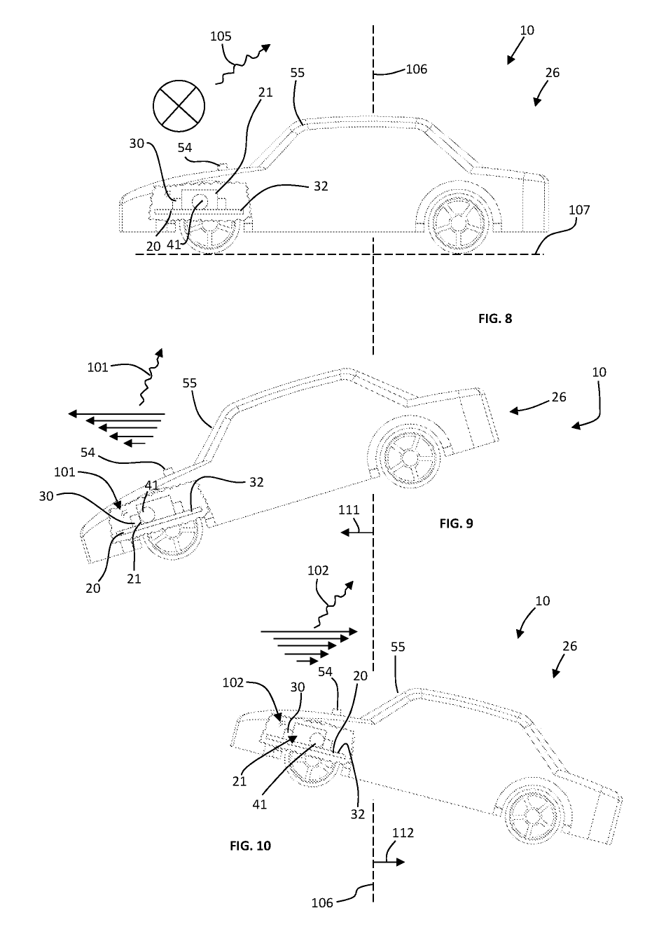

The reader will note the upright or vertical axis 106 of the user-operable control device 10 when in the equilibrium position, which axis 106 is orthogonal to the horizontal 107. Tilt positions cause the element 32 to move from a horizontal configuration into an angled orientation relative to the horizontal configuration thereby causing the spherical body 41 to roll within the current-conductive enclosure of the preferred tilt ball switch assembly 21 incorporated into the signal-transmitting circuitry or launcher mechanism 20 according to the present invention. Diagrammatic depictions of spherical body 41 movements within the current-conductive enclosure of the tilt ball switch assembly 21 are generally presented in FIGS. 8-13.

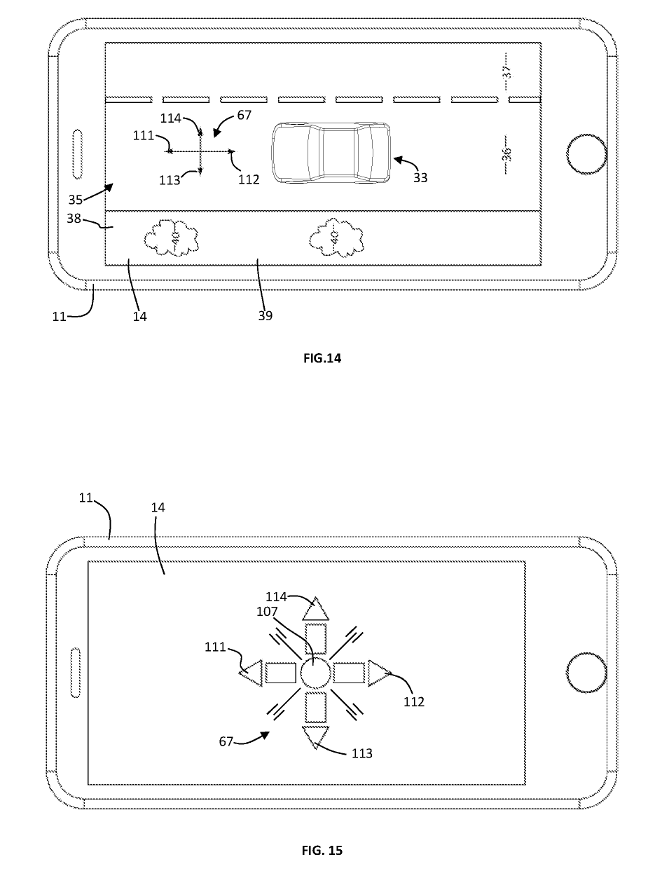

The user-operable control device(s) 10 may further preferably comprise an optional feature switch for sending non-tilt-based signals to the user's communication device or computer 100 for effecting further functionality within the gaming environment such as virtual shots fired, virtual character jumping or virtual audio functionality (e.g. virtual car horn honking). In this regard, the reader will note a push button 54 mounted externally relative to the toy car 26 type user-operable control device 10, which push button 54 is in communication with the signal-transmitting circuitry or launch mechanism 20 for enabling the user to implement the optional added feature of functionality. When the push button 54 is depressed a signal may be sent for triggering the added feature as generally depicted at circle 107 in FIG. 14.

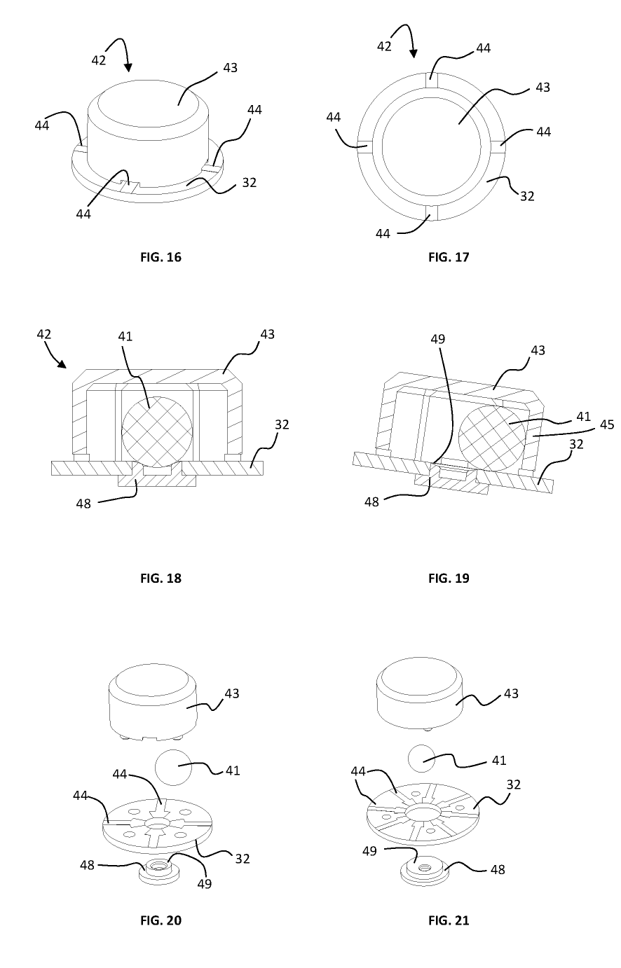

The tilt ball switch assembly 21 according to the present invention is preferred for its inexpensiveness and simple construction and is generally depicted in greater comparative detail in FIGS. 16-26A. As indicated, the tilt ball switch assembly 21 preferably comprises a current-conductive spherical body as at 41 and a current-conductive enclosure as at 42. The current-conductive spherical body 41 is rollably displaceable within the current-conductive enclosure 42 for effecting the directional movement signals exemplified by signals 101, 102, 103, and 104.

The current-conductive enclosure 42 preferably comprises a ball-supportive circuit board as at 32 and a ball-corralling shroud as at 43. The spherical body 41 is supported by the circuit board 32 and corralled by the ball-corralling shroud 43. Inner surface portions of the circuit board 32 and ball-corralling shroud 43 comprise conductive material portions for simultaneously and tangentially touching outer surfacing of the spherical body 41 for effecting the directional movement signals 101, 102, 103, and 104. Circuit board 32 comprises radially extending finger portions 44 outfitted with conductive surfacing and ball-corralling shroud 43 comprises orientation stopper formations 45 outfitted with conductive surfacing for closing circuitry via the conductive surfacing of spherical body 41 when tangentially touching and interconnecting the stopper formations 45 and finger portions 44.

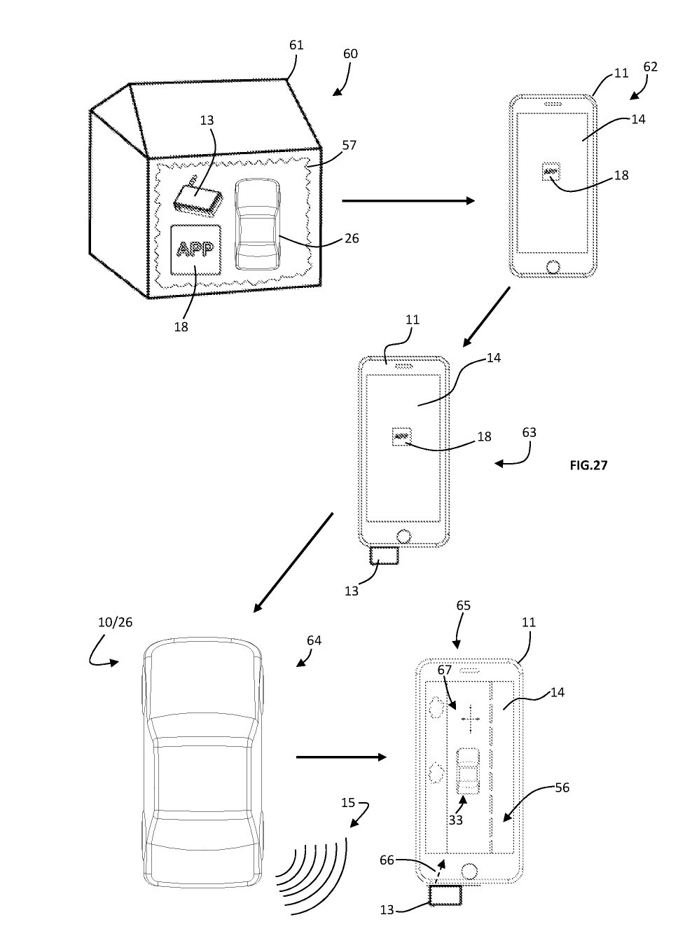

The stopper formations 45 of the ball-corralling shroud 43 preferably provide a series of body-receiving cradle formations 46 as more particularly illustrated in FIG. 26A. Each body-receiving cradle formation 46 is characterized by an arcuate transverse cross-section for receiving the spherical body 41 when directed therein and restricting lateral movement within the body-receiving cradle formations once received (via a corresponding tilt position) for enhancing the directional movement signals. In other words, when a user tilts the user-operable control device 10 into a chosen tilt position, the spherical body 41 enters the cradle formation 46 and slight lateral movements will not operate to displace the spherical body 41 from a corresponding signal-producing position since the arcuate transverse cross-section cradles the spherical body 41 and directs the spherical body 41 centrally as at center portion 47.

The current-conductive enclosure 42 may further preferably comprise a non-conductive insert element as at 48. The insert element 48 is upwardly concave at concave surfacing 49 for receiving the outer surfacing of spherical body 41. Accordingly, when the user-operable control device 10 is in the equilibrium position, the spherical body 41 may seat upon the concave surfacing 49 for retaining the equilibrium position of the spherical body 41 as generally depicted in FIG. 18. The insert element 48 is thus believed to enhance distinctions between signals initiated from current-conductive surfacing of the finger portions 44 and stopper formations 45 when the spherical body 4 is in a select tilt position versus the equilibrium position at horizontal.

The current-conductive enclosure 42 may further preferably comprise a series of position posts as at 50 and a series of non-conductive orientation divider portions as at 51 formed as part of the ball-corralling shroud 43. The circuit board 32 preferably comprises position post-receiving apertures 52 and a central insert-receiving aperture as at 53. The posts 50 are structurally positioned, sized and shaped for receipt in the position post-receiving apertures 52. The central insert-receiving aperture 53 is sized and shaped to receive the insert element 48. The divider portions structurally separate the conductive stopper portions 45 for enhancing signaling characteristics of the tilt ball switch assembly 21.

The foregoing specifications earlier suggested that any number of control signals could be implemented by the basic assemblies that cooperate to provide the user with the stated functionality. In this regard, it was further suggested that the preferred practice of the invention contemplated at least four primary directional signals as at 101, 102, 103, and 104 enabled via the signal-transmitting circuitry of the user-operable control device(s) 10. Referencing FIGS. 21, 23, and 25, the reader will there contemplate alternative current-conductive enclosure components 32 and 43 for enabling four secondary directional movement signals diagonally offset from the four primary directional movement signals.

In this last regard, the present invention contemplates providing the user with enhanced directional movements including movements diagonally offset from forward, rearward, leftward, and rightward directional movements 111, 112, 113, and 114 or directional movements that combine vectors in (a) the forward-leftward directions; (b) the forward-rightward directions; (c) the rearward-leftward directions; and (d) the rearward-rightward directions. Referencing FIG. 25, in particular, the reader will consider that the circuit board 32 may alternatively provide eight (8) finger portions 44, including four finger portions 44 in the 12:00, 3:00, 6:00, and 9:00 positions for effecting the four primary directional movements, and four finger portions 44 diagonally offset relative to the 12:00, 3:00, 6:00, and 9:00 positions for effecting diagonal movements.

The reader should further note that the wireless communications enabled via the signal-communicating dongle or similar other mechanism 13 can be connected with at least four toys at the same time for group play. By way of comparison, a blue tooth connection only allows a single toy to be connected for play thereby limiting gaming scenarios to single player applications. The present application thus enables group play. Further, the current electronic design in each respective toy assigns every individual toy its own identification. Thus, no two toys will be treated as the same toy, even though many different individual toys will have the same or similar appearance (and treated as the same toy in the retail sense). This feature allows the gaming application server to store game play results and achievement levels for each individual toy on a cloud-based server, which can be retrieved when the toy is in play the next time or for online interactive gaming.

While the foregoing specifications set forth much specificity, the same should not be construed as setting forth limits to the invention but rather as setting forth certain preferred embodiments and features. The present invention basically contemplates three aspects of a central invention, including a gaming system, kit and method for providing overlapping real-virtual world interactive play. The gaming system according to the present invention may be said to essentially and preferably comprise a computer as at 100, a user-operable control device as at 10, a signal-communicating mechanism as exemplified by signal-communicating dongle 13, and a gaming application (embraced or denoted by APP icon 18) implementable by the computer 100.

The computer preferably and essentially comprises a processor as depicted in a diagrammatic manner via broken away parts 120 and referenced at 110 in FIG. 5A and an electronic visual display 14 for enabling visual gaming. The user-operable control device 10 operates separate and apart from the computer 100 and preferably and essentially comprises circuitry housing 55 as illustratively exemplified by a toy car shape and appearance in FIGS. 6-13 and signal-transmitting circuitry as typified by launch mechanism 20. The signal-transmitting circuitry or launch mechanism 20 is housed within the circuitry housing 55 as generally depicted in FIGS. 6-13 and comprises a signal transmitter as diagrammatically depicted at component 30. The user-operable control device generates and transmits any number of virtual object control signals 15 (e.g. signals 101, 102, 103, and 104) enabled via the signal-transmitting circuitry.

In the preferred deployment, the user-operable control device 10 is hand-operable as in the case of a toy car embodiment at 26. The circuitry housing 55, for example, in the shape of a toy car, preferably comprises external contextual ornamentation reflective of the controllable and visually displayed virtual object 33 for enhancing the gaming experience. Further, certain portions of the signal-transmitting circuitry (e.g. the ball-supportive circuit board 32) are preferably mounted within the circuitry housing 55 so as to be orthogonal to an upright device axis as at 106 or parallel to the horizontal 107. The portions of the signal-transmitting circuitry are preferably so mounted for effecting an enhanced gaming experience via hand controllable movements of the circuitry housing relative to the upright device axis 106 or the horizontal 107.

It is contemplated that a signal-communicating mechanism such as a signal-communicating dongle 13 also be separately provided with the gaming system and made outfittable upon the computer via a component interface as exemplified by earphone jack 19. Alternatively, however, it is contemplated that the user-operable control device could be made wirelessly communicable directly with the computer 100 itself via wireless communications hardware pre-installed therewith and made communicable with the signal transmitter 30 for receiving the virtual object control signals 15 from the signal-transmitting circuitry and communicating the virtual object control signals to the processor 110 for further processing in connection with the gaming application.

The computer-implementable gaming application denoted by APP icon 18 is made operable via the processor 110 of the computer 100 and is thus deployable via the computer 100 for providing a controllable and visually displayed virtual object as at 33 upon the electronic visual display 14. The controllable and visually displayed virtual object 33 is virtually controllable in a virtual gaming environment as at 56 by way of the virtual object control signals 15 sent from the user-operable control device and communicated to the computer 100 via the signal-communicating mechanism exemplified by dongle 13.

Recalling that certain portions of the signal-transmitting circuitry are preferably and uniquely mounted within the circuitry housing 55, it should be noted that in a preferred embodiment, the signal-transmitting circuitry comprises a tilt switch, the tilt switch for generating the virtual object control signals 15 as exemplified by at least four primary directional signals 101, 102, 103, and 104. Further, the tilt switch may be preferably be defined by a ball bearing switch assembly as at 21, which assembly preferably further comprises a current-conductive spherical body as at 41 and a current-conductive enclosure as at 42. The current-conductive spherical body 51 is rollably displaceable within the current-conductive enclosure 42 for effecting the virtual object control signals 15.

The current-conductive enclosure 42 may preferably comprise the ball-supportive circuit board 32, as indicated, and a ball-corralling shroud as at 43. The spherical body or ball 41 is rollably supported by the ball-supportive circuit board 32 and corralled by the ball-corralling shroud 42. Inner surface portions of the ball-supportive circuit board 32 and ball-corralling shroud 43 comprises conductive material portions for simultaneously and tangentially touching outer surfacing of the spherical body 41 for generating the virtual object control signals 15.

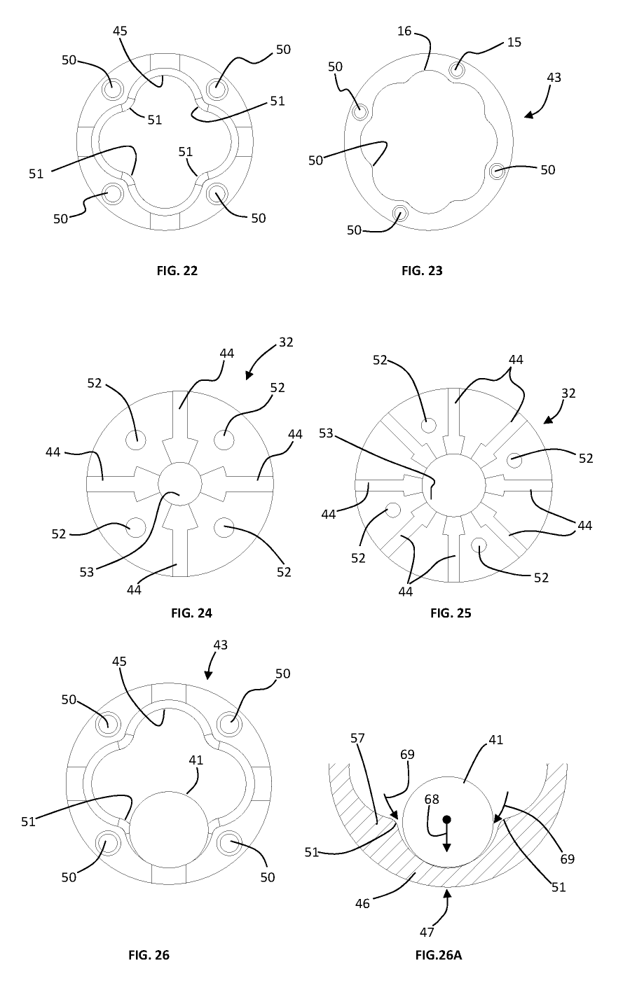

The ball-corralling shroud 43 may preferably comprise a series of body-receiving cradle formations 46, each being characterized by comprising an arcuate transverse cross-section as generally and comparatively depicted in FIGS. 22, 23, 26, and 26A. The body-receiving cradle formations 46 basically function to receive the spherical body 41 when directed therein under a chosen tilt position of the circuitry housing 55 and restricting lateral movement of the spherical body 41 within the body-receiving cradle formation(s) 46 once received therein. Thus, the body-receiving cradle formations 46 effectively function to enhance the virtual object control signals by virtue of limitations on ball movement within the cradle portions 46.

The gaming kit according to the present invention is diagrammatically depicted in FIG. 27 and referenced at 60. There the reader will see a box type packaging construction 61 with parts thereof broken away as at 57 to show otherwise hidden kit components provided to the user upon purchase or delivery. The gaming kit 60 is usable in combination with a user's communications device or computer 10 for providing an overlapping real-virtual world interactive game.

The gaming kit 60 according to the present invention may be said to preferably and essentially comprise a user-operable control device 10 as illustratively exemplified by a toy car 26, a signal-communicating mechanism exemplified by a signal-communicating dongle 13, and gaming application access instructions as denoted in FIG. 27 by an enlarged APP icon 18. In this regard, it is contemplated that providing the user with instructions for accessing the downloadable gaming application is more cost effective than providing the user with a software-bearing transfer medium, although the latter is believed embraced by APP icon 18 in the context of FIG. 27.

In other words, the game access instructions may well instruct a user on how to access a downloadable software-based gaming application from an off-site location, which gaming application is implementable via the user's communications device or computer 100, which software-based game, once accessed, is deployable upon the user's communications device or computer for providing a controllable and visually displayed virtual object as at 33 that is virtually controllable in the virtual gaming environment 56 by way of virtual object control signals 15 (e.g. directional movement signals) sent from the user-operable control device 10 and communicated to the user's communications device or computer 100 via the signal-communicating mechanism 13.

The gaming methodology according to the present invention enables communications device-based or computer-based play via a user-operable control device and may be said to comprise a series of steps generally depicted in FIG. 27. The gaming method according to the present invent ion may be said to comprise the initial step of providing the gaming kit 60 having at least a user-operable control device 10 (e.g. a toy car 26) and game access instructions as denoted by APP icon 18 contained therein. The electronic gaming application as denoted by APP icon 18 may then be accessed and downloaded to a user's communications device or computer 100 via the game access instructions. FIG. 27 depicts a smartphone 11 with an APP icon 18 denoted thereon in the second position 62.

Once the gaming application is installed on the user's communication device or computer 100, the electronic gaming application may be initiated or launched for providing an electronic game upon. The electronic game provides a controllable and visually displayed virtual object as at 33 within a virtual gaming environment as t 56. The user's communications device or computer may then be outfitted with a signal-communicating mechanism (e.g. signal-communicating dongle 13) at a signal-communication interface (e.g. earphone jack 19) and virtual object control signals 15 may be transmitted to the user's communications device or computer via the signal-communicating mechanism 13. Outfitting the smartphone 11 with a dongle 13 is generally depicted at position 63 in FIG. 27.

The step of transmitting virtual object control signals to the user's communications device or computer 100 via the user-operable control device 10 exemplified by a toy car 26 is generally depicted at position 64 in FIG. 27. The step of communicating the virtual object control signals 15 to the electronic gaming application via the user's communications device or computer is generally depicted in position 65 at vector arrow 66. The controllable and visually displayed virtual object 33 within the virtual gaming environment 56 may thus be controlled as symbolized by vector cross 67 via the virtual object control signals 15 transmitted from the user-operable control device 10.

Though not specifically illustrated, it is contemplated that the foregoing specifications well support a gaming method inclusive of or dependent upon certain signal-transmitting circuitry comprising a ball switch assembly having a current-conductive spherical body and a current-conductive enclosure, whereby the gaming method comprises the step of rollably displacing the spherical body within the current-conductive enclosure for effecting the virtual object control signals. Further, the gaming method contemplates a current-conductive enclosure having a ball-supportive circuit board and ball-corralling shroud whereby inner surface portions of the ball-supportive circuit board and ball-corralling shroud comprise conductive material portions.

Thus, the gaming method according to the present invention may be said to comprise the further optional or alternative steps of supporting the spherical body by the ball-supportive circuit board; corralling the spherical body by the ball-corralling shroud; and simultaneously tangentially touching outer surfacing of the spherical body via the inner surface portions of the ball-supportive circuit board and ball-corralling shroud for effecting the virtual object control signals. Further, the methodology contemplates the step of mounting the ball-supportive circuit board within the circuitry housing orthogonally relative to an upright device axis 106 for effecting an enhanced gaming experience via hand controllable movements of the circuitry housing 56 relative to the upright device axis.

Finally, noting that the ball-corralling shroud 43 comprises a series of body-receiving cradle formations as at 46 characterized by an arcuate transverse cross-section, the gaming method according to the present invention may be said to alternatively comprise the steps of receiving the spherical body 41 in at least one body-receiving cradle formation 46, and restricting lateral movements of the received spherical body 41 within the body-receiving cradle formation 46 once received therein. In this regard, it is noted that the spherical body 41 inherently comprises some mass as depicted at vector arrow 68 in FIG. 26A. The mass 68 is directed toward the cradle formation 46 when in a select tilt position and the opposed arcuate surfacing directs (as at vectors 69) the spherical body 41 centrally as at position 47.

Accordingly, although the invention has been described by reference to certain preferred and alternative embodiments, it is not intended that the novel arrangements be limited thereby, but that modifications thereof are intended to be included as falling within the broad scope and spirit of the foregoing disclosures, the appended drawings submitted in support of these specifications, and the following claims.

What is claimed is:

1. A gaming system for providing overlapping real-virtual world interactive play, the gaming system comprising:
a computer, the computer comprising a processor and an electronic visual display for enabling visualized gaming;
a user-operable control device separate from the computer, the user-operable control device comprising a circuitry housing and signal-transmitting circuitry, the signal-transmitting circuitry being housed within the circuitry housing and comprising a signal transmitter, the user-operable control device for generating and transmitting virtual object control signals enabled via the signal-transmitting circuitry;
a signal-communicating mechanism communicable with the signal transmitter for (a) receiving the virtual object control signals from the signal-transmitting circuitry and (b) communicating the virtual object control signals to the processor; and
a computer-implementable gaming application made operable via the processor of the computer, the gaming application thus being deployable via the computer for providing a controllable and visually displayed virtual object upon the electronic visual display, the controllable and visually displayed virtual object being virtually controllable in a virtual gaming environment by way of the virtual object control signals sent from the user-operable control device and communicated to the computer via the signal-communicating mechanism.

2. The gaming system of claim 1 wherein the signal-transmitting circuitry comprises a tilt switch, the tilt switch for generating the virtual object control signals.

3. The gaming system of claim 2 wherein the tilt switch is defined by a ball switch, the ball switch comprising a current-conductive spherical body and a current-conductive enclosure, the current-conductive spherical body being rollably displaceable within the current-conductive enclosure for effecting the virtual object control signals.

4. The gaming system of claim 3 wherein the current-conductive enclosure comprises a ball-supportive circuit board and a ball-corralling shroud, the spherical body being supported by the ball-supportive circuit board and corralled by the ball-corralling shroud, inner surface portions of the ball-supportive circuit board and ball-corralling shroud comprising conductive material portions for simultaneously and tangentially touching outer surfacing of the spherical body for effecting the virtual object control signals.

5. The gaming system of claim 4 wherein the ball-corralling shroud comprises a series of body-receiving formations, each body-receiving formation being characterized by an arcuate transverse cross-section, the body-receiving formations for receiving the spherical body when directed therein and restricting lateral movement of the spherical body within the body-receiving formations once received therein, the body-receiving formations thus for enhancing the virtual object control signals.

6. The gaming system of claim 1 wherein the computer comprises a signal-communication interface and the signal-communicating mechanism is outfittable upon the computer at the signal-communication interface for communicating signals from the signal transmitter to the computer.

7. A gaming kit usable in combination with a user's communications device for providing an overlapping real-virtual world interactive game, the gaming kit comprising:
a user-operable control device, the user-operable control device comprising a circuitry housing and signal-transmitting circuitry, the signal-transmitting circuitry being housed within the circuitry housing and comprising a tilt switch and a signal transmitter, the user-operable control device for governing at least four primary directional movements, the at least four primary directional movements for generating directional movement signals enabled via the tilt switch of the signal-transmitting circuitry;
a signal-communicating mechanism communicable with the signal transmitter for (a) receiving the directional movement signals from the signal-transmitting circuitry and (b) communicating the directional movement signals to the user's communications device; and
game access instructions for instructing a user on how to access a gaming application implementable via the user's communications device, the gaming application, once accessed, being deployable upon the user's communications device for providing a controllable and visually displayed virtual object, the controllable and visually displayed virtual object being virtually controllable in a virtual gaming environment by way of the directional movement signals sent from the user-operable control device and communicated to the user's communications device via the signal-communicating mechanism.

8. The gaming kit of claim 7 wherein the signal-communicating mechanism is outfittable upon the user's communications device at a signal-communication interface.

9. The gaming kit of claim 7 wherein the user-operable control device is hand-operable, the circuitry housing comprising an external contextual ornamentation, the external contextual ornamentation being reflective of the controllable and visually displayed virtual object for enhancing the gaming experience.

10. The gaming kit of claim 7 wherein the tilt switch is defined by a ball switch, the ball switch comprising a current-conductive spherical body and a current-conductive enclosure, the current-conductive spherical body being rollably displaceable within the current-conductive enclosure for effecting the directional movement signals.

11. The gaming kit of claim 10 wherein the current-conductive enclosure comprises a ball-supportive circuit board and a ball-corralling shroud, the spherical body being supported by the ball-supportive circuit board and corralled by the ball-corralling shroud, inner surface portions of the ball-supportive circuit board and ball-corralling shroud comprising conductive material portions for simultaneously and tangentially touching outer surfacing of the spherical body for effecting the directional movement signals.

12. The gaming kit of claim 11 wherein the ball-supportive circuit board is mounted within the circuitry housing so as to be orthogonal to an upright device axis, the ball-supportive circuit board being so mounted for effecting an enhanced gaming experience via hand controllable movements of the circuitry housing relative to the upright device axis.

13. The gaming kit of claim 11 wherein the ball-corralling shroud comprises a series of body-receiving cradle formations, each body-receiving cradle formation being characterized by an arcuate transverse cross-section, the body-receiving cradle formations for receiving the spherical body when directed therein and restricting lateral movements of the spherical body within the body-receiving cradle formations once received therein, the body-receiving formations thus for enhancing the directional movement signals.

14. A gaming method for enabling computer-based play via a user-operable control device, the gaming method comprising the steps of:
providing a gaming kit, the gaming kit comprising a user-operable control device and game access instructions, the user-operable control device comprising a circuitry housing and signal-transmitting circuitry, the signal-transmitting circuitry comprising a signal transmitter, the user-operable control device for generating and transmitting virtual object control signals;
accessing an electronic gaming application via the game access instructions upon user's computer;
initiating the electronic gaming application via the user's computer for providing an electronic game upon, the electronic game providing a controllable and visually displayed virtual object within a virtual gaming environment;
transmitting virtual object control signals to the user's computer via the user-operable control device;
communicating the virtual object control signals to the electronic gaming application via the user's computer; and
controlling the controllable and visually displayed virtual object within the virtual gaming environment via the virtual object control signals transmitted from the user-operable control device.

15. The gaming method of claim 14 comprising the step of hand-controlling the user-operable control device reflective of a contextually relevant object, the circuitry housing of the contextually relevant object comprising an external contextual ornamentation, the external contextual ornamentation being reflective of the controllable and visually displayed virtual object for enhancing the gaming experience.

16. The gaming method of claim 14 comprising the steps of:
outfitting the user's computer with a signal-communicating mechanism at a signal-communication interface; and
transmitting virtual object control signals to the user's computer via the signal-communicating mechanism.

17. The gaming method of claim 14 wherein the signal-transmitting circuitry comprises a ball switch, the ball switch comprising a current-conductive spherical body and a current-conductive enclosure, the gaming method comprising the step of rollably displacing the spherical body within the current-conductive enclosure for effecting the virtual object control signals.

18. The gaming method of claim 17 wherein the conductive enclosure comprises a ball-supportive circuit board and ball-corralling shroud, inner surface portions of the ball-supportive circuit board and ball-corralling shroud comprising conductive material portions, the gaming method comprising the steps of:
supporting the spherical body by the ball-supportive circuit board;
corralling the spherical body by the ball-corralling shroud; and
simultaneously tangentially touching outer surfacing of the spherical body via the inner surface portions of the ball-supportive circuit board and ball-corralling shroud for effecting the virtual object control signals.

19. The gaming method of claim 18 comprising the step of mounting the ball-supportive circuit board within the circuitry housing orthogonally relative to an upright device axis, the ball-supportive circuit board being so mounted for effecting an enhanced gaming experience via hand controllable movements of the circuitry housing relative to the upright device axis.

20. The gaming method of claim 19 wherein the ball-corralling shroud comprises a series of body-receiving cradle formations, each body-receiving cradle formation being characterized by an arcuate transverse cross-section, the gaming method comprising the steps of:
receiving the spherical body in at least one body-receiving cradle formation; and
restricting lateral movements of the received spherical body within the body-receiving cradle formation once received therein.
